(19) United States
(12) Patent Application Publication
(10) Pub. No.: US 2007/0062908 A1
(43) Pub. Date: Mar. 22, 2007

(54) Process for producing printed wiring board

(75) Inventor: Teruaki Yagi, Ageo-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: Mitsui Mining & Smelting Co., Ltd., Shinagawa-ku (JP)

(21) Appl. No.: 11/517,098

(22) Filed: Sep. 7, 2006

(30) Foreign Application Priority Data
Sep. 15, 2005 (JP) 2005-268290

(51) Int. Cl. H01B 13/00

(52) U.S. Cl. 216/13

(57) ABSTRACT

Disclosed is a process for producing a printed wiring board, comprising a step of treating a laminated film having a copper layer laminated on at least one surface of an insulating film, with a first etching solution containing cupric chloride or ferric chloride as a main constituent to reduce the thickness of the copper layer, and a step of treating the laminated film, which has been treated with the first etching solution, with a second etching solution containing sulfuric acid and hydrogen peroxide as main constituents to adjust the thickness of the copper layer. According to the process for producing a printed wiring board, the time required for treating the laminated film having a copper layer laminated on at least one surface of an insulating film to reduce the thickness of the copper film to a desired thickness is short, and besides, the thickness dispersion of the copper layer after the treatment is small.

### FIELD OF THE INVENTION

The present invention relates to a process for producing a printed wiring board (e.g., TAB (tape automated bonding) tape, COF (chip on film) tape, BGA (ball grid array) tape, CSP (chip size package) tape, ASIC (application specific integrated circuit) tape, FPC (flexible printed circuit)) on which an electronic component such as a semiconductor chip is to be mounted. In the present specification, the “printed wiring board” includes both of a tape wherein a wiring pattern is repeatedly formed in the lengthwise direction and a tape carrier obtained from this long tape after mounting of an electronic component.

### BACKGROUND OF THE INVENTION

For mounting electronic components such as IC (integrated circuit) and LSI (large scale integrated circuit) on liquid crystal display devices, printers or the like, various printed wiring boards have been employed. In recent years, downsizing, weight lightening and enhancement of functions of such equipment have been strongly demanded, and with the strong demands, fining and densification of conductor wiring patterns of the printed wiring boards have been promoted. Recently, printed wiring boards having a pitch width of less than 30 μm have been put into practical use.

In case of the printed wiring board having a wiring pattern of such a narrow pitch, COF (chip on film) system or the like is employed for mounting a semiconductor chip. In the production of a printed wiring board, formation of a wiring pattern on an insulating film has been heretofore carried out by the use of a subtractive process, a semi additive process, a fully additive process or the like, and as a process appropriate to formation of wiring of such a narrow pitch as described above, a semi additive process has been paid attention (patent documents 1 to 3).

Formation of a wiring pattern by the semi additive process is carried out in the following manner. First, a laminated film wherein a thin base metal layer is laminated on an insulating film such as a polyimide film is prepared.

On the surface of the base metal layer, a plating resist is formed so that only a portion of the base metal layer where the wiring pattern is to be formed should be exposed. The plating resist is formed by, for example, exposing and developing a photosensitive dry film or a liquid photoresist to form a pattern.

Then, on the exposed portion of the base metal layer which has not been coated with a plating resist, a metal plating layer is formed by electroplating or the like. The metal plating layer is formed in such a manner that the thickness of this layer becomes sufficiently larger than the thickness of the base metal layer, for example, about 10 μm.

Then, the plating resist is removed by an alkali solution or the like, and thereafter, the base metal layer remaining between the metal plating layers is removed by flash etching, whereby a wiring pattern is formed.

Patent document 1: Japanese Patent Laid-Open Publication No. 78234/2003

Patent document 2: Japanese Patent Laid-Open Publication No. 258411/2003

Patent document 3: Japanese Patent Laid-Open Publication No. 95983/2004

### OBJECT OF THE INVENTION

If the thickness of the base metal layer is large, the bottom of the side surface of the wiring is etched together with the base metal layer when the base metal layer is removed by flash etching, and an undercut is liable to occur at the edge of the wiring. On that account, the thickness of the base metal layer needs to be reduced. For example, in the case where a commercially available copper-clad laminate is used as a two-layer substrate, a copper layer of about 8 μm thickness is thinned to a thickness of 0.1 to 3 μm by chemical polishing, and the thus thinned copper layer is used.

If a sulfuric acid-hydrogen peroxide based etching solution or an ammonium persulfate based etching solution is used in order to obtain a thin base metal layer, the etching time required to thin the base metal layer to a desired thickness is extremely prolonged because the etching rate is low.

If a cupric chloride etching solution or a ferric chloride etching solution is used in order to obtain a thin base metal layer, it becomes difficult to control etching so that the thickness of the base metal layer should become uniform because the etching rate is high. Therefore, the thickness dispersion of the base metal layer after the etching treatment becomes large.

In case of such surface condition of a large thickness dispersion as mentioned above, adhesion of a dry film resist that is a plating resist to the base metal layer is lowered when the dry film resist is applied onto the base metal layer in the subsequent step. If the adhesion of the dry film resist is not satisfactory, a plating solution sometimes enters between the dry film resist and the base metal layer in the electroplating step, and a favorable wiring pattern is not obtained occasionally.

On the other hand, also in the case where a wiring pattern is formed by a subtractive process, the copper layer of the laminated film is sometimes thinned to a desired thickness before the wiring pattern is formed, and also in this case, there is a problem that it is difficult to obtain a copper layer having a desired small thickness and having a small thickness dispersion in a short period of time by the above process.

Accordingly, it is an object of the present invention to provide a process for producing a printed wiring board, wherein the time required for treating a laminated film having a copper layer laminated on at least one surface of an insulating film to reduce the thickness of the copper film to a desired thickness is short, and the thickness dispersion of the copper layer after the treatment is small.

It is another object of the present invention to provide a process for producing a printed wiring board, wherein in the formation of a wiring pattern by a semi additive process, a thin base copper layer having excellent adhesion to a resist can be obtained in a short treating time.

### SUMMARY OF THE INVENTION

The process for producing a printed wiring board according to the present invention comprises the steps of:

treating a laminated film having a copper layer laminated on at least one surface of an insulating film, with a first etching solution containing cupric chloride or ferric chloride as a main constituent to reduce the thickness of the copper layer, and

treating the laminated film, which has been treated with the first etching solution, with a second etching solution containing sulfuric acid and hydrogen peroxide as main constituents to adjust the thickness of the copper layer.

The process for producing a printed wiring board according to the invention further comprises the steps of:

forming a plating resist on the copper layer of the laminated film, which has been treated with the second etching solution, in such a manner that only a portion of the copper layer corresponding to a wiring pattern is exposed,

forming a metal plating layer on the exposed portion of the copper layer,

removing the plating resist from the laminated film, and

removing the copper layer remaining between the metal plating layers that become wiring, by means of flash etching.

In a preferred embodiment, the thickness of the copper layer is reduced to 2 to 5 μm by the use of the first etching solution, and then the thickness of the copper layer is adjusted to range from 0.1 to 2 μm by the use of the second etching solution. The invention is suitably applied to the process for producing a printed wiring board wherein a wiring pitch of the wiring pattern to be formed is less than 30 μm.

In a preferred embodiment, the first etching solution further contains hydrochloric acid. Preferably, the first etching solution contains 1 to 4 mol/liter of cupric chloride and 2 to 8 mol/liter of hydrochloric acid.

Preferably, the second etching solution contains 1.5 to 4.5 mol/liter of sulfuric acid and 1.0 to 4.0 mol/liter of hydrogen peroxide.

In a preferred embodiment, the treatment with the first etching solution is carried out by spray etching, and the treatment with the second etching solution is carried out by immersion etching.

### DETAILED DESCRIPTION OF THE INVENTION

The present invention is described in detail hereinafter. The laminated film for use in the invention is a laminated film having a copper layer laminated on at least one surface of an insulating film. More specifically, a two-layer film consisting of an insulating film and a copper layer or a three-layer film wherein an insulating film and a copper layer are laminated together with an adhesive is employable.

The two-layer film consisting of an insulating film and a copper layer is, for example, a two-layer film obtained by depositing a thin metal layer of nickel, chromium or the like on an insulating film by sputtering or the like and then forming a copper layer on the metal layer by electroplating or the like, a two-layer film obtained by thermally compression-bonding a copper foil having a carrier foil to an insulating film and then peeling the carrier foil or removing the carrier foil by etching, or a two-layer film obtained by casting. According to the casting method, a two-layer film is obtained by, for example, applying a resin solution of a polyimide precursor onto a copper foil, then drying and heating the resin layer to cure the resin.

The three-layer film is a film obtained by laminating an insulating film and a copper film together through an adhesive layer. Examples of the adhesives include an epoxy resin adhesive, an acrylic resin adhesive, a urethane resin adhesive, a polyimide adhesive and a polyamide adhesive. The thickness of the adhesive layer is in the range of usually 3 to 50 μm, preferably 6 to 25 μm.

The insulating film desirably has such chemical resistance as it is not attacked by an acid solution used for etching or an alkali solution used for cleaning and desirably has such heat resistance as it is not thermally deformed greatly by heating when an electronic component is mounted by bonding or the like.

Examples of the insulating films include a polyimide film, a polyimidoamide film, a polyester film, a polyphenylene sulfide film, a polyether imide film, a fluororesin film and a liquid crystal polymer film. In particular, a flexible film made of polyimide is preferably employed.

The insulating film has a mean thickness of usually 1 to 150 μm, preferably 5 to 125 μm, more preferably 15 to 75 μm. When the printed wiring board is COF, the insulating film is, for example, a polyimide film having a mean thickness of 15 to 75 μm, preferably 20 to 50 μm.

The copper layer laminated on the insulating film may be any of an electrodeposited copper foil and a rolled copper foil, or it may be a layer composed of a copper alloy containing copper as a main constituent.

Next, a case where a printed wiring board is produced by a semi additive process using the above-mentioned laminated film is described. As the laminated film, for example, a commercially available two-layer film whose copper layer has a thickness of about 8 μm is employable. Although a two-layer film whose copper layer has a thickness larger than this or a two-layer film whose copper layer has a thickness smaller than this may be used, preferable is a film in which the thickness dispersion of the copper layer is as small as possible.

The laminated film is treated with a first etching solution containing cupric chloride or ferric chloride as a main constituent to reduce the thickness of the copper layer. By the use of the first etching solution, the thickness of the copper layer is preferably reduced to 2 to 5 μm.

The treatment with the first etching solution is carried out by spray etching. The laminated film is unwound from an unwind reel and introduced at a constant rate into an etching chamber arranged between the unwind reel and a wind-up reel.

In the etching chamber, plural spray nozzles for spraying an etching solution are arranged on one surface side or both surface sides of the laminated film. The etching solution is continuously fed to the plural spray nozzles from an etching solution tank by means of a pump and uniformly sprayed onto the copper layer surface from the spray nozzles. As the spray nozzles, for example, those having an oscillating function to perform uniform spraying are employed. Spraying of the etching solution is carried out while the laminated film in a perpendicularly standing state or a horizontally laid state is conveyed in the etching chamber.

The etching solution containing cupric chloride as a main constituent, which is used as the first etching solution, contains at least cupric chloride and hydrochloric acid (HCl). The content of the cupric chloride is preferably in the range of 1 to 4 mol/liter, and the content of the hydrochloric acid (in terms of the content of hydrogen chloride (HCl)) is preferably in the range of 2 to 8 mol/liter.

The etching solution may contain an oxidizing agent such as hydrogen peroxide. In addition, small amounts of additives may be contained.

The temperature of the etching solution is preferably in the range of 30 to 60° C. The spray pressure is preferably in the range of 0.07 to 0.3 MPa. The amount of the etching solution sprayed onto the copper surface is preferably in the range of 60 to 750 liters/min·M².

The etching solution containing ferric chloride as a main constituent, which is used as the first etching solution, contains at least ferric chloride and hydrochloric acid (HCl). The content of the ferric chloride is preferably in the range of 1 to 4 mol/liter, and the content of the hydrochloric acid (in terms of the content of hydrogen chloride (HCl)) is preferably in the range of 1 to 4 mol/liter.

The etching solution may further contain small amounts of additives.

The temperature of the etching solution is preferably in the range of 30 to 60° C. The spray pressure is preferably in the range of 0.07 to 0.3 MPa. The amount of the etching solution sprayed onto the copper surface is preferably in the range of 60 to 750 liters/min·m².

After the laminated film is treated with the first etching solution, the laminated film is treated with a second etching solution containing sulfuric acid and hydrogen peroxide to adjust the thickness of the copper layer to a desired thickness. When a wiring pattern is formed by a semi additive process, it is preferable to adjust the thickness of the copper layer to a thickness ranging from 0.1 to 2 μm by the use of the second etching solution.

The treatment with the second etching solution is carried out by immersion etching. The laminated film is unwound from an unwind reel and introduced into an etching bath of the second etching solution arranged between the unwind reel and a wind-up reel. It is possible to carry out the spray etching using the first etching solution and the immersion etching using the second etching solution in this order between the same unwind reel and the same wind-up reel.

The second etching solution contains at least sulfuric acid (H₂SO₄) and hydrogen peroxide (H₂O₂). The content of the sulfuric acid is preferably in the range of 1.5 to 4.5 mol/liter, and the content of the hydrogen peroxide is preferably in the range of 1.0 to 4.0 mol/liter.

The second etching solution may further contain appropriate amounts of copper ion, sulfate and hydrogensulfate. Moreover, other additives, such as a stabilizer for hydrogen peroxide, may be contained in small amounts.

The temperature of the second etching solution is preferably in the range of 20 to 50° C.

In the treatment with the first etching solution, rapid etching is possible because the etching rate is high, but the copper layer obtained herein has a thickness dispersion of about ±1.0 to ±2.0 μm based on the mean thickness. On the other hand, in the treatment with the second etching solution, the etching rate is low, but the copper layer is more rapidly etched at the place where the flow of the etching solution (renewal of etching solution) is faster on the interface between the copper layer and the etching solution, and therefore, on the copper layer surface, the protruded portion is more rapidly etched than the depressed portion. On that account, the thickness dispersion of the copper layer becomes smaller, and finally, the thickness dispersion can be decreased to about ±0.1 to ±0.8 μm.

By treating the laminated film in two steps using the first etching solution and the second etching solution as described above, a surface having excellent adhesion to a plating resist can be finished in a short period of time, and the cost to obtain a metal layer that becomes a base for the semi additive process can be reduced.

Using the laminated film wherein the thickness of the copper layer that becomes a base has been adjusted in the above manner, a plating resist is formed on the surface of the copper layer in such a manner that a portion of the copper layer where a wiring pattern is to be formed is exposed. The plating resist is formed by exposing and developing a photosensitive dry film or a liquid photoresist to form a pattern.

After the plating resist is formed, a metal plating layer is formed on the portion where a plating resist has not been applied and the copper layer is exposed. The metal plating layer is preferably formed by electroplating, and in order to form a metal plating layer composed of, for example, copper, electroplating using a copper sulfate bath and using the copper layer of the laminated film as a common electrode is employable. The thickness of the metal plating layer is in the range of usually 1 to 70 μm, preferably 4 to 35 μm. In order to form a wiring pattern having a pitch of not more than 30 μm, the wiring height as the total height of the base copper layer and the metal plating layer is usually not more than 12 μm, preferably not more than 10 μm.

Then, the plating resist is removed by an alkali solution or the like, and thereafter, the base metal layer remaining between the metal plating layers is removed by flash etching, whereby a wiring pattern is formed. The wiring pitch is generally in the range of 25 to 50 μm, but as pitch fining is promoted, the wiring pitch sometimes becomes less than 25 μm. The process of the invention is particularly suitable for forming a wiring pattern having a pitch of less than 30 μm.

After the wiring pattern is formed as above, a solder resist is applied so as to cover the whole surface of the wiring pattern region except inner leads which are to be connected to terminals of a semiconductor chip and outer leads which are to be connected to external equipment on the input side and the output side. Thereafter, the inner leads and the outer leads exposed from the solder resist are subjected to terminal plating, whereby a printed wiring board is obtained.

The solder resist is formed by applying and curing a resist ink by means of screen printing or by applying a photosensitive dry film.

The terminal plating is, for example, tin plating, nickel plating, nickel-gold plating, Cu—Sn plating or Sn—Bi plating.

Although a case of forming a wiring pattern by a semi additive process is described above, the present invention is also applicable to a case of forming a wiring pattern by a subtractive process. In this case, any of the aforesaid various two-layer films and three-layer films is employable as the laminated film. For example, a commercially available laminated film is employable. The mean thickness of the copper layer is in the range of usually 1 to 70 μm, preferably 4 to 35 μm.

The laminated film is treated with the aforesaid first etching solution containing cupric chloride or ferric chloride as a main constituent to reduce the thickness of the copper layer. By the use of the first etching solution, the mean thickness of the copper layer is preferably reduced to “mean thickness desired to be finally obtained+1 to 5 μm”.

After the laminated film is treated with the first etching solution, the laminated film is treated with the aforesaid second etching solution containing sulfuric acid and hydrogen peroxide to adjust the thickness of the copper layer. By virtue of these treatments, a copper layer of a desired thickness having a thickness dispersion of, for example, about ±0.1 to ±0.8 μm is obtained.

Thereafter, the copper layer of the laminated film is coated with a dry film resist or a liquid photoresist, then the resist is irradiated with ultraviolet light through a mask to cure the portion corresponding to a wiring pattern to be formed, and the resist of the uncured portion is dissolved and removed by the use of a developing solution. A photoresist that becomes soluble in a medium by exposure is also employable.

Then, the copper layer other than the copper layer protected by the resist is dissolved and removed by etching using an acid, whereby a wiring pattern is formed on the surface of the insulating film. The resist on the wiring pattern is removed by an alkali solution or the like.

The inner leads of the printed wiring board obtained as above and external terminals of a semiconductor chip are thermally compression-bonded by the use of a bonding tool or the like, whereby an electronic component such as a semiconductor chip is mounted.

After the semiconductor chip is mounted, a resin such as an epoxy resin is introduced through a device hole provided in the insulating film or in case of a COF tape or the like through a gap between the insulating film and the semiconductor chip, to seal joints between the inner leads and the external terminals of the semiconductor chip. Thus, a semiconductor device is obtained.

### Effect of the Invention

According to the present invention, the treatment to thin the copper layer to a desired thickness can be carried out in a short period of time, and besides, the thickness dispersion of the copper layer after the treatment is small.

According to the present invention, further, in the formation of a wiring pattern by a semi additive process, a thin base copper layer having excellent adhesion to a resist can be obtained in a short period of time.

### EXAMPLE

The present invention is further described with reference to the following examples, but it should be construed that the invention is in no way limited to those examples.

### Example 1

A commercially available two-layer film wherein a copper layer was laminated on a polyimide film (Espanex, available from Nippon Steel Chemical Co., Ltd., mean thickness of copper layer: 8 μm) was prepared.

With conveying the two-layer film in spray equipment, a cupric chloride based first etching solution (40° C.) containing 2 mol/liter of cupric chloride and 4 mol/liter of HCl was uniformly sprayed onto the copper layer of the two-layer film from nozzles of the spray equipment at a spray pressure of 0.15 MPa to perform etching for about 10 seconds.

The thickness of the copper layer after etching was measured in the following manner. Using a contact film thickness gauge (ME-50H, manufactured by Nikon Corporation), the thickness of the copper layer was measured at the total 25 measuring points on the copper layer, namely, 5 measuring points at regular intervals of 8 mm in the crosswise direction and 5 measuring points at regular intervals of 50 mm in the lengthwise direction. The mean thickness of the copper layer was 2.98 μm, the standard deviation aσ of the thickness was 0.538 μm, and the thickness dispersion was 3σ, namely, 1.614 μm.

Then, the two-layer substrate was conveyed and immersed in an etching solution containing 3.0 mol/liter of H₂SO₄, 2.8 mol/liter of H₂O₂ and several tens ppm of additives to perform etching at 30° C. for about 90 seconds.

The thickness of the copper layer after etching was measured in the above manner. As a result, the mean thickness of the copper layer was 1.44 μm, the standard deviation σ of the thickness was 0.162 μm, and the thickness dispersion was 3σ, namely, 0.486 μm.

On the copper layer of the two-layer substrate, a dry film resist of 15 μm thickness (ALPHO NIT215, available from Nichigo-Morton Co., Ltd.) was laminated. The lamination was carried out under the conditions of a temperature of about 100° C., a pressure of 0.3 MPa and a laminating rate of 2.0 m/min.

The dry film resist was exposed at about 80 mJ/cm² and then developed for about 15 seconds by spraying a 1% Na₂CO₃ aqueous solution under the conditions of a temperature of 30° C., to form a pattern corresponding to wiring.

Then, the two-layer substrate was treated with FR (trade name, available from Atotech Japan Co., Ltd.) 10%+20% H₂SO₄ at a temperature of 40° C. for 180 seconds and successively treated with 10% H₂SO₄ at a temperature of 30° C. for 60 seconds to perform plating pretreatment.

Thereafter, using a plating solution containing 60 g/liter of CuSO₄.5H₂O, 210 g/liter of H₂SO₄, 50 ppm of chloride ion and several ppm of additives, copper electroplating was carried out for about 20 minutes under the conditions of a temperature of 23° C. and Dk of 2.0 A/dm² to form a copper plating layer of 9 μm thickness.

Then, a 3% NaOH aqueous solution at a temperature of 50° C. was sprayed onto the dry film resist for about 15 seconds by means of a spray to remove the resist.

Thereafter, an etching solution containing 4.1 mol/liter of H₂SO₄, 3.3 mol/liter of H₂O₂ and several tens ppm of additives was sprayed for about 20 seconds under the conditions of a temperature of 30° C. to perform flash etching and thereby remove the copper layer remaining between the copper plating layers. Thus, a wiring pattern having a wiring pitch of 25 μm (line width: 13 μm, space width: 12 μm) was formed. Thereafter, a solder resist was applied so as to cover the wiring pattern except the lead portion, and the lead portion was subjected to terminal plating to obtain a printed wiring board.

The printed wiring board obtained hardly suffered undercut of wiring, and because the plating resist sufficiently adhered to the copper layer surface, an excellent wiring pattern was obtained.

1. A process for producing a printed wiring board, comprising the steps of:
treating a laminated film having a copper layer laminated on at least one surface of an insulating film, with a first etching solution containing cupric chloride or ferric chloride as a main constituent to reduce the thickness of the copper layer, and
treating the laminated film, which has been treated with the first etching solution, with a second etching solution containing sulfuric acid and hydrogen peroxide as main constituents to adjust the thickness of the copper layer.

2. The process for producing a printed wiring board as claimed in claim 1, further comprising the steps of:
forming a plating resist on the copper layer of the laminated film, which has been treated with the second etching solution, in such a manner that only a portion of the copper layer corresponding to a wiring pattern is exposed,
forming a metal plating layer on the exposed portion of the copper layer,
removing the plating resist from the laminated film, and
removing the copper layer remaining between the metal plating layers that become wiring, by means of flash etching.

3. The process for producing a printed wiring board as claimed in claim 2, wherein the thickness of the copper layer is reduced to 2 to 5 μm by the use of the first etching solution, and then the thickness of the copper layer is adjusted to range from 0.1 to 2 μm by the use of the second etching solution.

4. The process for producing a printed wiring board as claimed in claim 3, wherein a wiring pitch of the wiring pattern to be formed is less than 30 μm.

5. The process for producing a printed wiring board as claimed in claim 1, wherein the first etching solution further contains hydrochloric acid.

6. The process for producing a printed wiring board as claimed in claim 5, wherein the first etching solution contains 1 to 4 mol/liter of cupric chloride and 2 to 8 mol/liter of hydrochloric acid.

7. The process for producing a printed wiring board as claimed in claim 1, wherein the second etching solution contains 1.5 to 4.5 mol/liter of sulfuric acid and 1.0 to 4.0 mol/liter of hydrogen peroxide.

8. The process for producing a printed wiring board as claimed in claim 1, wherein the treatment with the first etching solution is carried out by spray etching, and the treatment with the second etching solution is carried out by immersion etching.
